(19) United States
(12) Patent Application Publication
(10) Pub. No.: US 2026/0303450 A1
(43) Pub. Date: Oct. 1, 2026

(54) DEPLOYING ON-DEMAND REDUNDANT NETWORK GATEWAYS

(71) Applicant: Nokia Solutions and Networks Oy, Espoo (FI)

(72) Inventor: Shailesh PRABHU, Bangalore (IN)

(73) Assignee: Nokia Solutions and Networks Oy, Espoo (FI)

(21) Appl. No.: 19/090,783

(22) Filed: Mar. 26, 2025

(51) Int. Cl. H04L 41/0816; H04L 43/0817

(52) U.S. Cl. CPC H04L 41/0816; H04L 43/0817; H04L 41/08

(57) ABSTRACT

A network manager for a plurality of network gateways monitors operations in the network gateways, determines that a particular network gateway needs assistance, provisions a redundant gateway for the particular network gateway using network resources that can alternatively be provisioned as a redundant gateway for at least one other network gateway, monitors operations in the particular network gateway and the redundant gateway, determines that the redundant gateway is no longer needed, and terminates the redundant gateway. The network manager provisions redundant gateways on demand as needed, thereby efficiently using network resources.

### BACKGROUND

### Field of the Disclosure

The present disclosure relates to computer-based communication networks and, more specifically but not exclusively, to software-defined networks (SDNs).

### Description of the Related Art

This section introduces aspects that may help facilitate a better understanding of the disclosure. Accordingly, the statements of this section are to be read in this light and are not to be understood as admissions about what is prior art or what is not prior art.

A software-defined network (SDN) typically consists of a network virtualization overlay with one or more logically centralized controllers managing an IP-based underlay. In large enterprise networks, the end devices (users) are logically connected to several network gateways (NGs) to leverage the virtualized services offered by the network with the help of SDN controllers.

A network gateway typically has its access network to serve various end users. When several NGs are deployed in large communication service provider (CSP) (or enterprise) networks, at certain circumstances/events, there might be an unexpectedly high traffic flow to a given NG. This could be due to the dynamic nature of the network, unexpected user mobility in bulk, or increasing consumption of high bandwidth and computationally intensive application services (like immersive video).

### SUMMARY

With growing networks, there is a critical demand for deploying cost-effective network infrastructure. At the same time, with increasing user density and high-bandwidth application services consumption (like video), there is also a need for a huge number of reliable gateways in the data plane to serve the ever-growing user traffic. Today's systems and methods lack the mechanism of dynamically increasing network gateway reliability by adding on-demand network infrastructure to support the users'demand at loaded access networks. The present disclosure is directed to technology to design/plan and deploy on-demand redundant gateways that can assist the data plane network gateways in balancing traffic and processing loads. This way, the reliability of the services offered by data plane gateways is enhanced, thereby retaining user experience.

The present technology proposes to design/plan data plane network infrastructure cost-effectively, by deploying redundant gateways (wherever necessary) and thereby enhancing reliability at gateway networks. Certain proposed methods monitor the network gateway metrics to observe any performance degradation using certain thresholds. The methods also include the on-demand deployment of redundant gateways (with shunt interfaces linked to loaded network gateways) with a similar configuration as the associated NGs. The methods terminate any redundant gateway that is no longer required, based on evaluating relevant metrics from both the RG and the associated NG.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of the architecture of a generic software-defined network, according to certain embodiments of the present disclosure;

FIG. 2 is a block diagram of a network gateway of FIG. 1 and a redundant gateway servicing an access network;

FIG. 3 is a flow diagram of the processing performed by the NG monitoring block of FIG. 1 for each NG, according to certain implementations;

FIG. 4 is a message flow diagram of the processing involved in provisioning a redundant gateway, such as the RG of FIG. 2, for a particular network gateway of FIG. 1, according to certain embodiments of the disclosure;

FIG. 5 is a flow diagram of the processing performed by the RG termination block of FIG. 1 for each redundant gateway, such as the RG of FIG. 2, according to certain implementations; and

FIG. 6 is a simplified hardware block diagram of an example node that can be used to implement any of the nodes of FIGS. 1 and 2.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

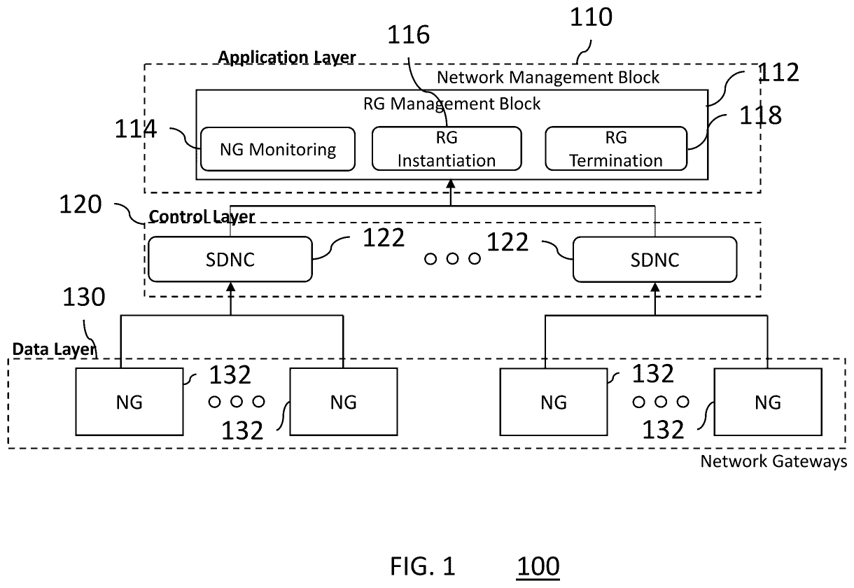

FIG. 1 is a block diagram of the architecture of a generic software-defined network 100, according to certain embodiments of the present disclosure. As represented in FIG. 1, SDN 100 has an application-layer plane 110 comprising a redundant gateway (RG) management block 112, a control-layer plane 120 comprising one or more SDN controllers (SDNCs) 122, and a data-layer plane 130 comprising one or more network gateways (NGs) 132. RG management block (RMB) 112 includes NG monitoring block 114, RG instantiation block 116, and RG termination block 118. Each SDNC 122 controls one or more NGs 132, where each NG services one or more end devices (i.e., user equipment (UE)) (not shown in FIG. 1).

Each NG 132 is the “last-mile” access gateway to which users logically connect to access various services offered by the SDN 100. Each SDNC 122 is a centralized authority that manages, controls, and provisions the data plane 130 with application-layer services.

The RMB 112 monitors the network 100 for any unexpectedly high traffic flow to the individual NGs 132 and deploys an on-demand redundant gateway (not shown in FIG. 1) in an affected NG's vicinity to ensure enhanced user experience. In particular, the NG monitoring block 114 monitors the bandwidth consumption (along with other metrics) at the individual NGs 132 and reports any drastic increase in NG's traffic flow to the RG instantiation block 116, which instantiates a redundant gateway at the affected NG's site and links the redundant gateway to the NG via a shunt interface. The RG termination block 118 terminates an already-spawned redundant gateway if and when the combination of the redundant gateway the associated NG 132 return to sufficiently low traffic flow in their access network.

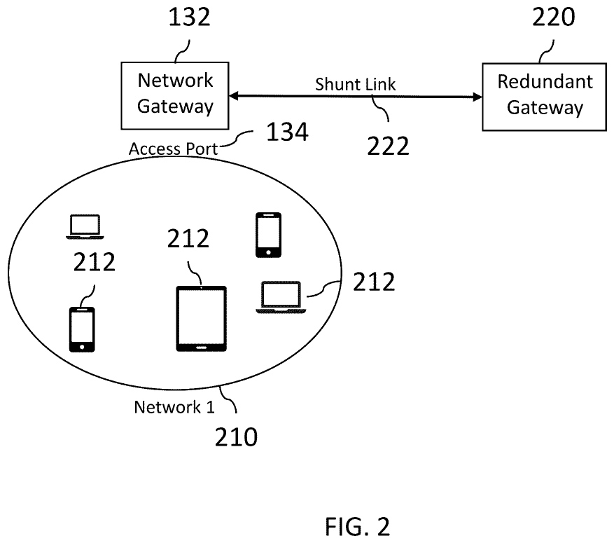

FIG. 2 is a block diagram of a network gateway 132 of FIG. 1 servicing an access network 210 comprising a number of different end devices 212 (e.g., cell phones, tablets, laptops, desktop computers) via an access port 134 of the NG 132. Those skilled in the art will understand that, depending on the implementation, the end devices 212 may include wireless and/or wired devices that are connected to the NG 132 via corresponding wireless and/or wired links.

As shown in FIG. 2, an on-demand redundant gateway 220 has been provisioned that communicates with the NG 132 via shunt link 222 to assist NG 132 in supporting the end devices 212. The shunt link 222, which, depending on the implementation, may be a wired or wireless, physical or logical connection, supports the exchange of data packets as well as control messages between the NG 132 and the RG 220.

As explained above, when the NG monitoring block 114 of FIG. 1 determines that NG 132 of FIG. 2 needs additional support, RG instantiation block 116 will provision redundant gateway 220 to assist NG 132 via shunt link 222. If and when RG 220 is no longer needed, RG termination block 118 will terminate RG 220, returning traffic being handled back to NG 132 and freeing up the network resources used for RG 220 to be used to assist a different (e.g., nearby) network gateway 132 or even the same NG 132 at a later time, as needed. In this way, network resources can be provisioned on demand as needed by a variety of different network gateways 132 without having to tie up those network resources permanently to support only specific network gateways 132.

The amount of load in a network can be determined using user density (ud) (i.e., the number of active end devices served by the NG 132), CPU usage (cu), and memory usage (mu). Note that, in this implementation, network resource usage, such as bandwidth, latency, and/or jitter, is not used, because the network management block 110 is capable of provisioning more network resources to the NG 132 itself to address these metrics rather than spawning a redundant gateway.

The above metrics (ud, cu, and mu) are sent by each NG 132 periodically to the NG monitoring block 114, which compares these metrics against the following thresholds:
User density threshold (tud): the average of the user density values for a specific NG 132. This threshold may be different for different NGs, because the user distribution in an NG can vary with various factors like application, geolocation, form factor, etc.;
Compute usage threshold (tcu): the average CPU consumption of an NG 132 over a specific time period; and
Memory usage threshold (tmu): the average memory consumption of an NG 132 over a specific time period.

At any point in time, if the user density (ud), the CPU usage (cu), or the memory usage (mu) exceeds a specific multiple (X) of the corresponding threshold (tud, tcu, tmu), then the NG monitoring block 114 reports this information to the RG instantiation block 116. The value of the specific multiple (X) is decided by the network administration. Since the thresholds tud, tcu, and tmu are average values, although X can be set to 1, the network administrator can selectively set X to a value greater than 1, such as 1.5, to configure the thresholds to be slightly above the average values.

When the NG metrics of a particular network gateway 132 cross any of the three thresholds, the NG 132 is considered to be a “loaded” gateway. Such loaded gateways are susceptible to performance degradations or crashes. As such, the RG instantiation block 116 spawns an on-demand redundant gateway (such as RG 220 of FIG. 2) with a similar configuration as the loaded NG 132 and deployed at the loaded NG site with its shunt interface linked to the loaded NG via a shunt link (such as shunt link 222 of FIG. 2). This RG serves as a backup or a load balancer to the NG 132, thereby retaining user experience.

This technology also helps design a data plane network infrastructure based on traffic consumption in the network gateway. In conventional software-defined networks, redundant gateways are pre-configured with a network gateway without estimating the need for an RG in that site. In this case, the RG may or may not be of critical need to some of the NG sites due to low traffic flow. In the present disclosure, the data plane network infrastructure is determined based on the need, by placing a redundant gateway only at those sites where NGs are loaded. This way, the capabilities of an RG are effectively utilized, along with saving network infrastructure costs (by not unnecessarily deploying RGs where there is no need).

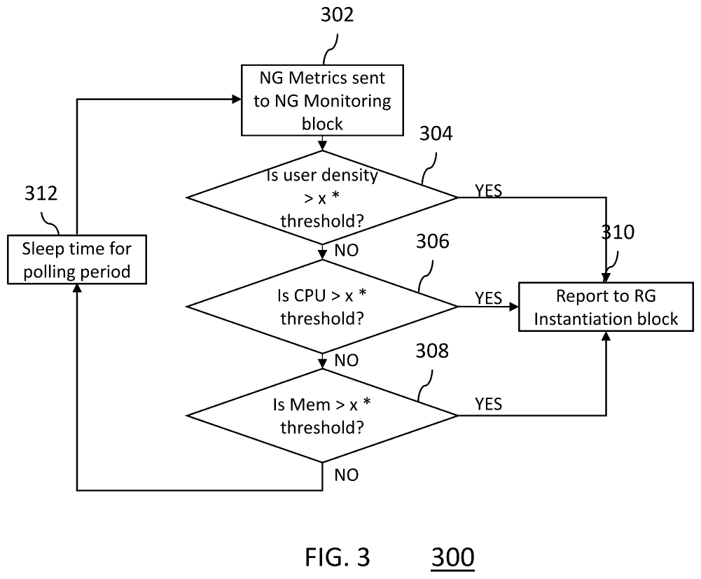

FIG. 3 is a flow diagram of the processing 300 performed by the NG monitoring block 114 of FIG. 1 for each NG 132, according to certain implementations. In step 302, the NG monitoring block 114 receives NG metrics (ud, cu, and mu) from the NG 132. In step 304, the NG monitoring block 114 compares the user density (ud) to the corresponding threshold (X*tud). If ud exceeds (X*tud), then processing proceeds to step 310, where the NG monitoring block 114 reports that information to the RG instantiation block 116, which provisions a redundant gateway for the NG 132. Otherwise, processing proceeds to step 306.

In step 306, the NG monitoring block 114 compares the CPU usage (cu) to the corresponding threshold (X*tcu). If cu exceeds (X*tcu), then processing proceeds to step 310 as before. Otherwise, processing proceeds to step 308.

In step 308, the NG monitoring block 114 compares the memory usage (mu) to the corresponding threshold (X*tmu). If mu exceeds (X*tmu), then processing proceeds to step 310 as before. Otherwise, processing proceeds to step 312, where the NG monitoring block 114 sleeps for a specified duration until the time to start the next polling period at step 302.

Virtually spawned redundant gateways are typically hosted on a hypervisor in virtualized network environments. These redundant gateways function as virtual network functions (VNFs) or cloud-native network functions (CNFs) in NFV (Network Functions Virtualization) architectures. A hypervisor (like VMware ESXi, KVM, or Hyper-V) manages the virtual machines (VMs) running the redundant gateway software. The virtual redundant gateway can route, translate, and secure network traffic just like a physical gateway. If deployed in a cloud-native environment, it may instead run as a containerized function orchestrated by Kubernetes (K8s), often using lightweight hypervisors like Kata Containers for isolation. If the redundant gateway is a physical device, then it operates as a dedicated hardware appliance rather than being virtualized on a hypervisor.

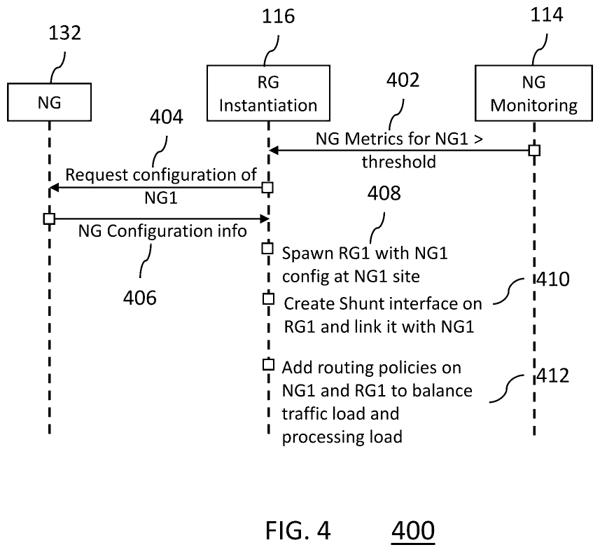

FIG. 4 is a message flow diagram of the processing 400 involved in provisioning a redundant gateway, such as RG 220 of FIG. 2, for a particular network gateway 132 of FIG. 1, according to certain embodiments of the disclosure. In step 402, the NG monitoring block 114 of FIG. 1 notifies the RG instantiation block 116 that at least one of the metrics for the NG 132 exceeded its threshold.

In response, in step 404, the RG instantiation block 116 requests the necessary configuration information (policies, access control lists, application settings, compute settings, routing configuration, etc.) from the NG 132. In response, in step 406, the NG 132 provides that configuration information to the RG instantiation block 116.

In step 408, the RG instantiation block 116 uses the received configuration information to spawn the redundant gateway. In step 410, the RG instantiation block 116 creates a shunt interface on the RG and links it with the NG 132, as in shunt link 222 of FIG. 2. In step 412, the RG instantiation block 116 adds routing policies (in the form of flow rules) to the NG 132 and the RG to balance traffic and processing loads, where the percentages of offloading are configurable parameters by the network administrator.

When the combined metrics for a redundant gateway and its associated network gateway all fall within their respective thresholds, then the redundant gateway is no longer needed. In that case, the processing being handled by the redundant gateway can be shifted back to the associated network gateway and the redundant gateway can be terminated to free up its corresponding network resources to assist another network gateway as needed. As understood by those skilled in the art, the applied thresholds may include a hysteresis value to avoid chattering in the provisioning and terminating of redundant gateways.

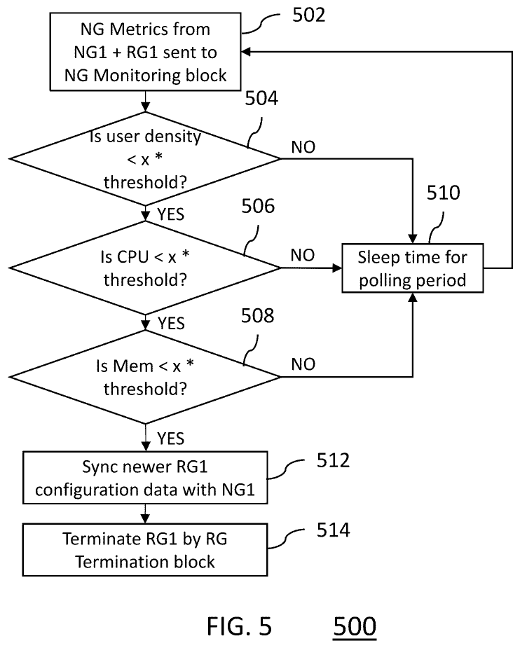

FIG. 5 is a flow diagram of the processing 500 performed by the RG termination block 118 of FIG. 1 for each redundant gateway, such as RG 220 of FIG. 2, according to certain implementations. In step 502, the RG termination block 118 receives NG metrics (ud, cu, and mu) corresponding to the sums of the metrics for the redundant gateway and the corresponding NG 132. In step 504, the RG termination block 118 compares the combined user density (ud) to the corresponding threshold (X*tud). If ud does not exceed (X*tud), then processing proceeds to step 510, where the RG termination block 118 sleeps for a specified duration until the time to start the next polling period at step 502. Otherwise, processing proceeds to step 506.

In step 506, the RG termination block 118 compares the combined CPU usage (cu) to the corresponding threshold (X*tcu). If cu does not exceed (X*tcu), then processing proceeds to step CE as before. Otherwise, processing proceeds to step 308.

In step 508, the RG termination block 118 compares the combined memory usage (mu) to the corresponding threshold (X*tmu). If mu does not exceed (X*tmu), then processing proceeds to step CE as before. Otherwise, processing proceeds to step 512.

Over the course of time, the redundant gateway may contain additional configuration and other information (regarding users, services, etc.) of which the NG 132 is unaware. As such, before terminating the redundant gateway, the additional configuration and other information present in the redundant gateway are synchronized to the NG 132 via the shunt interface. Without this synchronization, the NG 132 may fail to deliver services to its access users. Hence, final synchronization (of user and config/service information) via the shunt link is an important part of the termination process of a redundant gateway. Thus, in step 512, the RG termination block 118 syncs the current RG configuration data with the NG 132, before the RG termination block 118 terminates the RG in step 514.

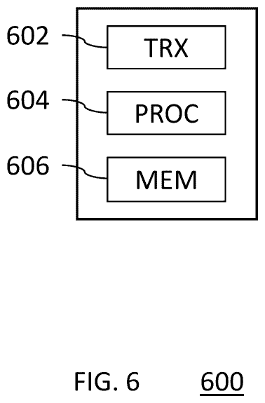

FIG. 6 is a simplified hardware block diagram of an example node 600 that can be used to implement any of the nodes of FIGS. 1 and 2. As shown in FIG. 6, the node 600 includes (i) communication hardware (e.g., wireless, wireline, and/or optical transceivers (TRX)) 602 that supports communications with other nodes, (ii) one or more processors (e.g., CPU and/or GPU microprocessors) 604 that control the operations of the node 600 and/or process data within the node 600, and (iii) one or more memories (e.g., RAM, ROM) 606 that store code executed by the processors 604 and/or data generated and/or received by the node 600.

Although the disclosure has been described in the context of decisions based on a set of three metrics consisting of user density, CPU usage, and memory usage, those skilled in the art will understand that the disclosure can also be implemented in the context of decisions based on alternative sets of one or more metrics selected from user density, CPU usage, memory usage, and one or more other suitable metrics such as CPU temperature, disk input/output latency, disk utilization, CPU core utilization,

Although the disclosure has been described in the context of software-defined networks, those skilled in the art will understand that the disclosure may also be implemented in the context of other suitable types of communication networks such as software-defined wide area networks (SDWANs), cloud-native networks, network function virtualization (NFV)-based networks, etc.

In certain embodiments, the present disclosure is a network manager for a plurality of network gateways. The network manager comprises at least one processor and at least one memory storing instructions that, upon being executed by the at least one processor, cause the network manager at least to monitor operations in the network gateways; determine that a particular network gateway needs assistance; provision a redundant gateway for the particular network gateway using network resources that can alternatively be provisioned as a redundant gateway for at least one other network gateway; monitor operations in the particular network gateway and the redundant gateway; determine that the redundant gateway is no longer needed; and terminate the redundant gateway.

In at least some of the above embodiments, before terminating the redundant gateway, the network manager is configured to sync data from the redundant gateway back to the particular network gateway.

In at least some of the above embodiments, the network manager comprises a network gateway monitor configured to monitor one or more metrics for the particular network gateway to determine whether to provision the redundant gateway; a redundant gateway instantiator configured to provision the redundant gateway; and a redundant gateway terminator configured to determine whether to terminate the redundant gateway.

In at least some of the above embodiments, the network gateway monitor is configured to compare each metric to a corresponding threshold to determine whether to provision the redundant gateway, and the redundant gateway terminator is configured to compare each metric to the corresponding threshold to determine whether to terminate the redundant gateway.

In at least some of the above embodiments, the one or more metrics include user density, processor usage, and memory usage.

In at least some of the above embodiments, the one or more metrics are the user density, the processor usage, and the memory usage.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A network manager for a plurality of network gateways, the network manager comprising:
at least one processor; and
at least one memory storing instructions that, upon being executed by the at least one processor, cause the network manager at least to:
monitor operations in the network gateways;
determine that a particular network gateway needs assistance;
provision a redundant gateway for the particular network gateway using network resources that can alternatively be provisioned as a redundant gateway for at least one other network gateway;
monitor operations in the particular network gateway and the redundant gateway;
determine that the redundant gateway is no longer needed; and
terminate the redundant gateway.

2. The network manager of claim 1, wherein, before terminating the redundant gateway, the network manager is configured to sync data from the redundant gateway back to the particular network gateway.

3. The network manager of claim 1, comprising:
a network gateway monitor configured to monitor one or more metrics for the particular network gateway to determine whether to provision the redundant gateway;
a redundant gateway instantiator configured to provision the redundant gateway; and
a redundant gateway terminator configured to determine whether to terminate the redundant gateway.

4. The network manager of claim 3, wherein:
the network gateway monitor is configured to compare each metric to a corresponding threshold to determine whether to provision the redundant gateway; and
the redundant gateway terminator is configured to compare each metric to the corresponding threshold to determine whether to terminate the redundant gateway.

5. The network manager of claim 3, wherein the one or more metrics include user density, processor usage, and memory usage.

6. The network manager of claim 5, wherein the one or more metrics are the user density, the processor usage, and the memory usage.

7. A method for a network manager for a plurality of network gateways, the method comprising the network manager:
monitoring operations in the network gateways;
determining that a particular network gateway needs assistance;
provisioning a redundant gateway for the particular network gateway using network resources that can alternatively be provisioned as a redundant gateway for at least one other network gateway;
monitoring operations in the particular network gateway and the redundant gateway;
determining that the redundant gateway is no longer needed; and
terminating the redundant gateway.

8. The method of claim 7, wherein, before terminating the redundant gateway, the network manager syncs data from the redundant gateway back to the particular network gateway.

9. The method of claim 7, wherein the network manager comprises:
a network gateway monitor that monitors one or more metrics for the particular network gateway to determine whether to provision the redundant gateway;
a redundant gateway instantiator that provisions the redundant gateway; and
a redundant gateway terminator that determines whether to terminate the redundant gateway.

10. The method of claim 9, wherein:
the network gateway monitor compares each metric to a corresponding threshold to determine whether to provision the redundant gateway; and
the redundant gateway terminator compares each metric to the corresponding threshold to determine whether to terminate the redundant gateway.

11. The method of claim 9, wherein the one or more metrics include user density, processor usage, and memory usage.

12. The method of claim 11, wherein the one or more metrics are the user density, the processor usage, and the memory usage.
